(19) United States
(12) Patent Application Publication
(10) Pub. No.: US 2024/0262142 A1
(43) Pub. Date: Aug. 8, 2024

(54) RETRACTABLE HITCH ASSEMBLY

(71) Applicant: Spider Hitch Inc., Donnelly (CA)

(72) Inventors: Real Garant, Donnelly (CA); Norm Lavoie, St Isidore (CA)

(21) Appl. No.: 18/618,753

(22) Filed: Mar. 27, 2024

(30) Foreign Application Priority Data
Feb. 7, 2023 (CA) 3188830

(51) Int. Cl. B60D 1/38

(52) U.S. Cl. CPC B60D 1/38

(57) ABSTRACT

A retractable hitch assembly has a stationary hitch receiver and a retractable hitch. The stationary hitch receiver has a hitch-receiving receptacle, and the retractable hitch has a first end that is sized to be received by the hitch-receiving receptacle and a second end that has a hitch connection. A releasable latch releasably secures the first end of the retractable hitch within the hitch-receiving receptacle. A retractable cable extends through the hitch-receiving receptacle and between the first end of the retractable hitch and the stationary hitch receiver. The retractable cable has an extended state in which the retractable hitch is permitted to extend from the stationary hitch receiver, and a retracted state in which the retractable hitch is received within the hitch-receiving receptacle.

### TECHNICAL FIELD

This relates to a retractable hitch assembly, and in particular a retractable hitch assembly with a nested connection.

### BACKGROUND

When mounting a trailer to the hitch of a vehicle, a retractable hitch may be used to facilitate the connection. Retractable hitches typically have a flexible line, such as a cable, chain, rope, etc., that connects between the vehicle and a hitch connector. By extending and retracting the flexible line, the hitch connector can be moved away from the vehicle, connected to the trailer-portion of the hitch, and then pulled toward the vehicle without having to move the vehicle. Retractable hitches allow for direct supervision by the vehicle operator, and avoids the risks associated with backing a vehicle into position to make up a hitch connection.

U.S. Pat. No. 7,497,458 (Daniel) entitled “Power retractable trailer hitch” and U.S. Pat. No. 11,383,567 (Yoshizaki) entitled “Vehicles having a retractable hitch” describe examples of retractable hitch assemblies.

### SUMMARY

According to an aspect, there is provided a retractable hitch assembly, comprising a stationary hitch receiver and a retractable hitch. The stationary hitch receiver comprises a hitch-receiving receptacle. The retractable hitch has a first end that is sized to be received by the hitch-receiving receptacle and a second end that comprises a hitch connection. A releasable latch releasably secures the first end of the retractable hitch within the hitch-receiving receptacle. A retractable cable extends through the hitch-receiving receptable and between the first end of the retractable hitch and the stationary hitch receiver. The retractable cable has an extended state and a retracted state, wherein, in the extended state, the retractable hitch is permitted to extend from the stationary hitch receiver, and in the retracted state, the retractable hitch is received within the hitch-receiving receptacle

According to other aspects, the retractable hitch may comprise one or more of the following features, alone or in combination: the retractable hitch may comprise a latch-engaging profile that engages the releasable latch when the retractable cable is in the retracted state, the releasable latch being biased toward an engaged position; the retractable hitch may be released by actuating the releasable latch and pulling the first end of the retractable hitch from the hitch-receiving receptacle; the releasable latch may comprise a locking bar biased downward, and the retractable hitch may comprise a ramp that pivots the locking bar outward prior to the locking bar engaging the latch-engaging profile; the retractable hitch may comprise an outer sleeve and a cable connector that nests within the outer sleeve, the cable connector comprising an inner cavity that houses and secures an end of the retractable cable such that the retractable cable extends out of inner cavity through the first end of the retractable hitch; the cable connector may comprise a load-bearing surface that transfers a load applied by the retractable cable through the outer sleeve to the hitch connection of the retractable hitch; the retractable hitch may further comprise a cap fixed to the first end, and the load-bearing surface of the cable connector may engage a complementary load-bearing surface of the cap when the cable connector is nested within the outer sleeve, such that the load applied by the retractable cable is transferred through the cap to the outer sleeve; the retractable cable may be secured to the cable connector by a pin disposed within the inner cavity, the pin being held by the outer sleeve when nested; and the retractable cable may be carried by a winch that is disposed in a winch housing, wherein the winch housing may comprise a covered top and an open bottom.

According to an aspect, there is provided a method of hitching a trailer to a vehicle, the method comprising the steps of extending a retractable hitch from a stationary hitch receiver secured to the vehicle, the stationary hitch receiver comprising a hitch-receiving receptacle, the retractable hitch having a first end that is sized to be received by the hitch-receiving receptacle and a second end that comprises a hitch connection for attaching to the trailer, the first end of the retractable hitch being connected to a retractable cable that extends through the hitch-receiving receptacle, attaching the hitch connection of the retractable hitch to the trailer, retracting the retractable cable from an extended state to a retracted state in which the retractable hitch is received within the hitch-receiving receptacle, and securing the first end of the retractable hitch within the hitch-receiving receptacle with a releasable latch.

According to other aspects, the method of hitching a trailer to a vehicle may comprise one or more of the following features, alone or in combination: the step of securing the first end of the retractable hitch in the retracted state may comprises biasing the releasable latch towards an engaged position, and engaging a latch-engaging profile of the retractable hitch with the releasable latch when the first end is received within hitch receiving receptacle and the releasable latch is in the engaged position; the method may further comprise the step of releasing the retractable hitch by releasing the releasable latch and pulling the first end of the retractable hitch from the hitch-receiving receptacle; the releasable latch may comprise a locking bar that is biased downward, and the step of securing the first end of the retractable hitch in the retracted state may further comprise causing the locking bar to move upward on a ramp of the retractable hitch prior to the locking bar engaging the latch-engaging profile; and the step of retracting the retractable cable from the extended state to the retracted state may comprise operating a winch to retract the retractable cable, the winch carrying the retractable cable and being housed in a winch housing that has a covered top and an open bottom.

According to an aspect, there is provided a method of assembling a retractable hitch, the method comprising the steps of passing a terminal end of a retractable cable through a hitch-receiving receptacle of a stationary hitch receiver, attaching the terminal end of the retractable cable to a cable connector, the terminal end of the retractable cable being secured to the cable connector within an inner cavity of a cable connector, nesting the cable connector within an outer sleeve to form a retractable hitch, the retractable hitch being sized to be received within the hitch-receiving receptacle, the outer sleeve being connected to a hitch connection, and attaching a releasable latch to the stationary hitch receiver, the releasable latch being configured to releasably secure the retractable hitch within the hitch-receiving receptacle.

According to other aspects, the method of assembling a retractable hitch may comprise one or more of the following features, alone or in combination: the step of attaching the terminal end of the retractable cable to the cable connector may comprise attaching the cable to a pin disposed within the inner cavity, the pin being held by the outer sleeve when the cable connector is nested within the outer sleeve; the retractable cable may be attached to a winch housed within the stationary hitch receiver, and the terminal end of the retractable cable may extend away from the winch; the cable connector may comprise a load-bearing surface that transfers a load applied by the retractable cable through the outer sleeve to the hitch connection of the retractable hitch;

and the method may further comprise the step of fixing a cap on a first end of the retractable hitch, wherein the cap comprises a complementary load bearing surface that engages the load-bearing surface of the cable connector.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a retractable hitch assembly with a retractable cable in an extended state.

FIG. 2 is a perspective view of a retractable hitch assembly with a retractable cable in a retracted state.

FIG. 3 is a side elevation view of a retractable hitch assembly with a retractable cable in a retracted state.

FIG. 4 is a bottom plan view of a stationary hitch receiver and a retractable hitch of a retractable hitch assembly.

FIG. 5 is a side elevation view of a stationary hitch receiver and a retractable hitch of a retractable hitch assembly with an attached ball hitch.

FIG. 6 is front elevation view of a stationary hitch receiver and a retractable hitch of a retractable hitch assembly.

FIG. 7 is a partially transparent side elevation view of a retractable hitch of a retractable hitch assembly.

FIG. 8 is a perspective view of a cable connector of a retractable hitch.

FIG. 9 is a perspective view of a retractable hitch assembly connected between a vehicle and a trailer with a retractable cable in an extended state.

FIG. 10 is a perspective view of retractable hitch assembly connected between a vehicle and a trailer with a retractable cable in a retracted state.

FIG. 11 is a perspective view of a trailer hitched to a vehicle using a retractable hitch.

### DETAILED DESCRIPTION OF PREFERRED EMBODIMENTS

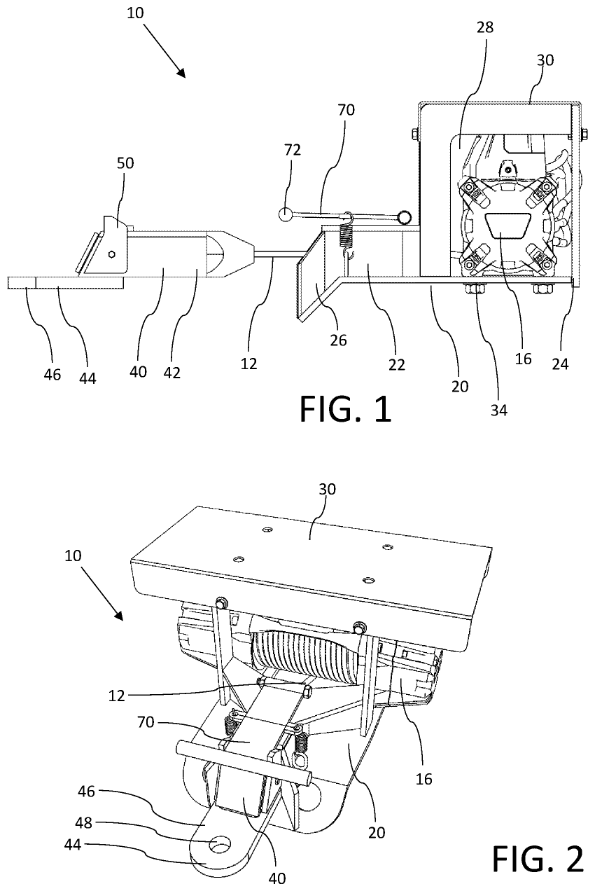

A retractable hitch assembly, generally identified by reference numeral 10, will now be described with reference to FIG. 1 through 11.

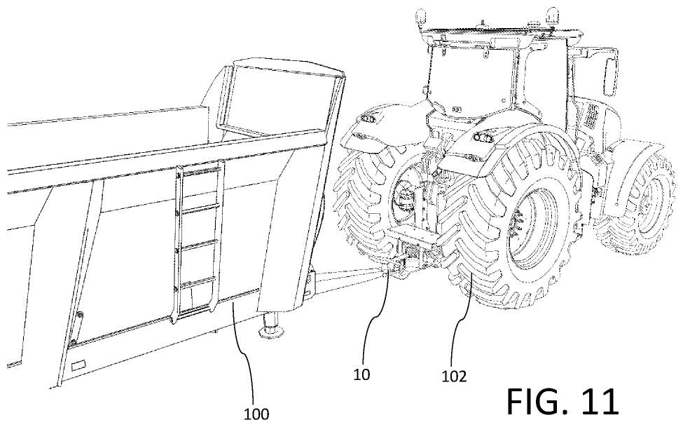

Referring to FIG. 11, retractable hitch assembly 10 is designed to attach a trailer 100 to a vehicle 102 through the use of a retractable cable 12, which allows the trailer 100 to be attached while it is located a certain distance away from vehicle 102. While vehicle 102 is depicted as a tractor, vehicle 102 could be another type of prime mover, such as a passenger vehicle, semitruck, heavy equipment, etc. Vehicle 102 may not be self-powered and may be a towed vehicle or trailer, such as a leading trailer in a double or triple trailer combination. In addition, while trailer 100 is depicted as a piece of towed agricultural equipment, trailer 100 may be another type of trailer, such as a cargo trailer, towed vehicle, towed equipment for various industries, etc.

Referring to FIG. 1, retractable hitch assembly 10 has a stationary hitch receiver 20 with a hitch receiving receptacle 22 and a retractable hitch 40 that is sized to fit within hitch receiving receptacle 22. Receptacle 22 may be generally tubular and may be non-circular to maintain the orientation of hitch 40 when received therein.

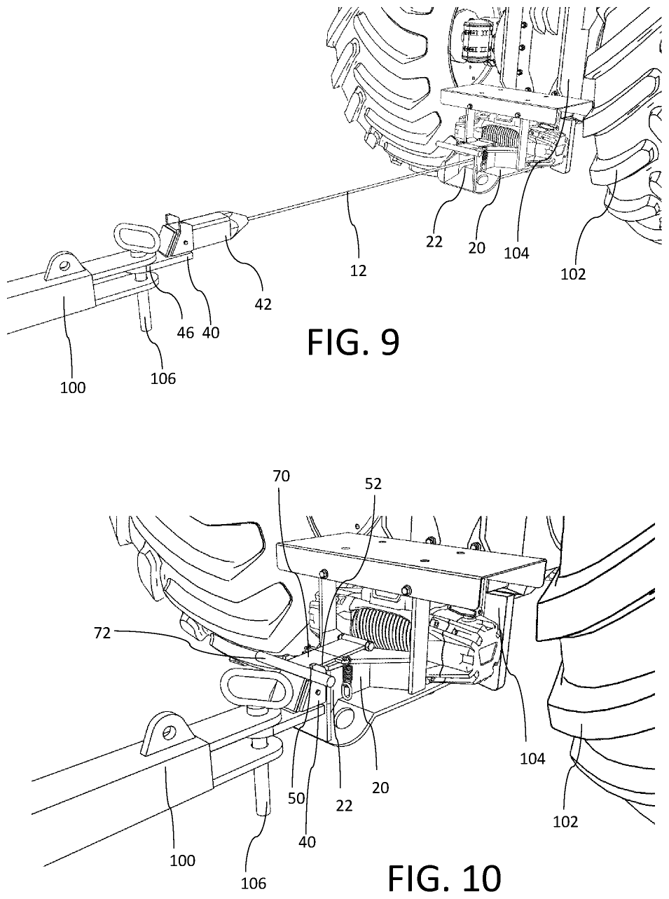

Referring to FIG. 9, retractable hitch 40 is able to be released from stationary hitch receiver 20 and extends to connect to trailer 100. Stationary hitch receiver 20 is typically attached to a back end 104 of vehicle 102 at an attachment location 24. Attachment location 24 may be a vertical plate adapted for attachment to the chassis of vehicle 102 or other suitable attachment configuration. There may be a series of holes (not shown) that allow for attachment to different hole patterns on vehicle 102. When mounted to vehicle 102, hitch-receiving receptacle 22 faces away from attachment location 24.

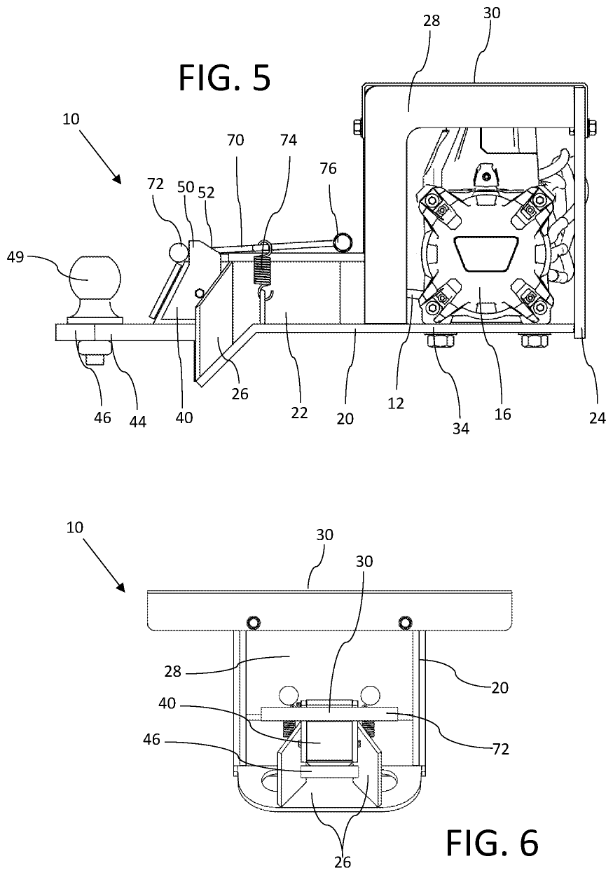

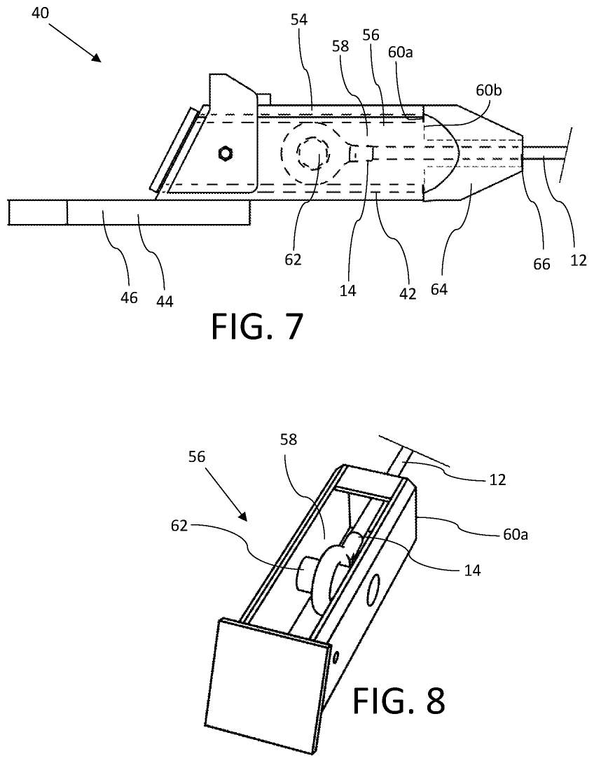

Referring to FIG. 1, retractable hitch 40 has a first end 42 that is sized to be received by hitch-receiving receptacle 22, and a second end 44 that has a hitch connection 46. Hitch connection 46 may be any type of structure that facilitates the connection of retractable hitch 40 to trailer 100. Referring to FIG. 2, hitch connection 46 may have a connection aperture 48 that permits a pin connection with a complementary hitch, as shown in FIGS. 9 and 10. In other examples, connection aperture 48 may be used to install a different type of hitch, such as a ball hitch 49 as shown in FIG. 5. Hitch connection 46 may be designed to support other types of hitches, such as a pintle hitch, in which case hitch connection 46 may be disposed below outer sleeve 54 to avoid impeding cable connector 56 (as discussed below with respect to FIG. 7).

Hitch-receiving receptacle 22 is sized to receive a first end 42 of retractable hitch 40. Hitch-receiving receptacle 22 and first end 42 are preferably formed with complementary shapes that fit snugly when first end 42 is received within hitch-receiving receptable 22 to reduce movement of retractable hitch 40 relative to hitch-receiving receptable 22 while trailer 100 is being towed by vehicle 102.

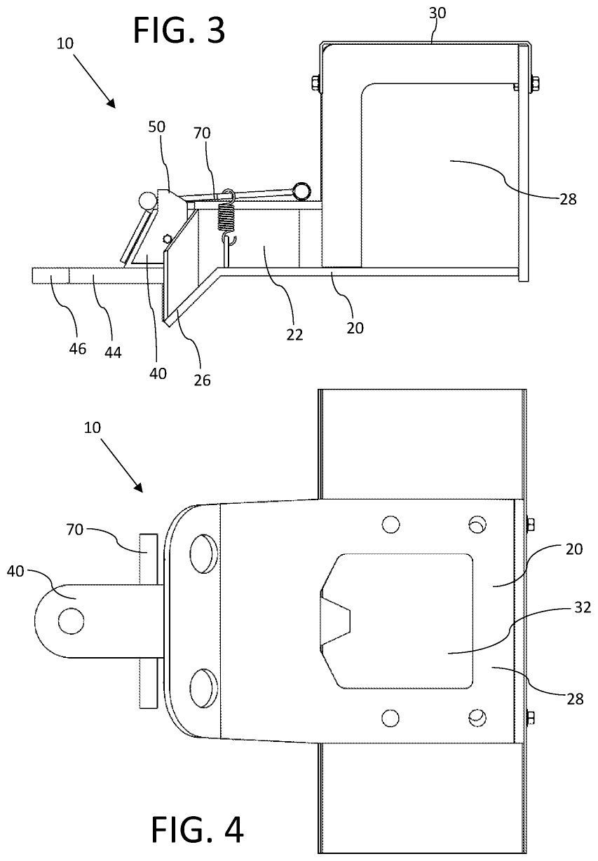

Retractable cable 12 extends between first end 42 of retractable hitch 40 and stationary hitch receiver 20. As shown, cable 12 extends out from within hitch-receiving receptacle 22 such that, as cable 12 is retracted, retractable hitch 40 is pulled into hitch-receiving receptacle 22. First end 42 of hitch receiver 20 may be connected to a terminal end 14 of retractable cable 12 as will be discussed below, and retractable cable 12 may be carried by a winch 16 that is stationary relative to stationary hitch receiver 20. Retractable cable 12 has an extended state, illustrated in FIG. 1 and FIG. 9, in which retractable hitch 40 is permitted to extend away from stationary hitch receiver 20, and a retracted state, illustrated in FIG. 2 and FIG. 10, that causes retractable hitch 40 to be received within hitch-receiving receptacle 22. Referring to FIG. 3, a releasable latch 70 releasably secures first end 42 of retractable hitch 40 within hitch-receiving receptacle 22 by preventing first end 42 from being removed from hitch receiving receptacle when releasable latch 70 is engaged. Releasing releasable latch 70 may put retractable cable 12 into the extended state and allow retractable hitch 40 to be extended away from stationary hitch receiver 20 for connection to trailer 100. Other steps may be necessary for retractable cable 12 to be in the extended state, such as releasing winch 16 to unspool cable 12.

Retractable hitch assembly 10 may have a winch housing 28 which houses winch 16. Winch housing 28 may be a part of hitch receiver 20 such that winch 16 is disposed adjacent to hitch-receiving receptable 22. Winch housing 28 may have a covered top 30 as shown in FIG. 2, and an open bottom 32 as shown in FIG. 4, to protect against debris from above and to allow any accumulated debris to fall below. Covered top 30 may be used as step for an operator of vehicle 102. Winch 16 may be located in any location that allows for retractable cable 12 to pass through hitch-receiving receptacle 22, such that retractable cable 12 is able to unspool through hitch-receiving receptacle 22 to allow retractable hitch 40 to be pulled back to trailer 100, and retracted by winch 16 to nest retractable hitch 40 within hitch-receiving receptacle 22 as shown in FIG. 5.

Referring to FIG. 5, retractable hitch 40 may have a latch-engaging profile 50 that engages releasable latch 70 when retractable hitch 40 is in a connected state with stationary hitch receiver 20. When in the connected state, releasable latch 70 may primarily bear the load applied between stationary hitch receiver 20 and retractable hitch 40 while vehicle 102 is pulling trailer 100. Retractable hitch 40 may be released by actuating releasable latch 70 and pulling first end 42 from hitch receiving receptacle with retractable cable 12 in the extended state. As depicted, releasable latch 70 pivots about a pivot point 76 at one end and carries a locking bar 72 at the opposite end, and is biased in a downward direction by a spring 74. Retractable hitch 40 may have a ramp surface 52 that causes locking bar 72 to pivot outward prior to locking bar 72 engaging latch engaging profile 50 as retractable hitch 40 is received within hitch-receiving receptacle 22.

Referring to FIG. 7, retractable hitch 40 has an outer sleeve 54 and a cable connector 56 that nests within outer sleeve 54. Referring to FIG. 8, cable connector 56 may have an inner cavity 58 that houses and secures terminal end 14 of retractable cable 12 such that retractable cable 12 extends out of inner cavity 58 through first end 42 of retractable hitch 40. Terminal end 14 may 14 may be secured to cable connector 56 by a pin 62 disposed within inner cavity 58, with pin 62 being in place by outer sleeve 54 when cable connector 56 is nested therein.

Referring to FIG. 7, cable connector 56 and outer sleeve 54 are connected such that a load applied by retractable cable 12 is transferred to outer sleeve 54 and ultimately hitch connection 46. In the depicted example, cable connector has a load-bearing surface 60a at a rear end that engages a complementary load bearing surface 60b carried by outer sleeve 54 when cable connector 56 is nested within outer sleeve 54.

In the depicted example, complementary load bearing surface 60b is carried by a cap 64 that is fixed to first end 42 and transfers the load applied by the load-bearing surface 60a to outer sleeve 54. The applied load may also be transferred to a different location of outer sleeve 54 or retractable hitch 40 either instead of or in addition to through load-bearing surface 60a. Cap 64 may be substantially conical or pyramidal in shape, such that retractable cable 12 extends out of an opening 66 of cap 64, where cap 64 narrows. Complementary load bearing surface 60b surrounds opening 66 at the wider end of cap 64. As shown, cap 64 may be welded to outer sleeve 54 to provide a continuous surface and improved strength. The tapered shape cap 64 may help guide retractable hitch 40 into engagement with hitch-receiving receptacle 22 and outer sleeve 54 may preferably have a smooth outer surface to prevent any catching between first end 42 and hitch-receiving receptacle 22 while retractable hitch 40 is being inserted. Additionally, referring to FIG. 6, stationary hitch receiver 20 may include guiding surfaces 26 that directs first end 42 into hitch receiving receptable 22 as shown in FIG. 1.

Retractable hitch assembly 10 may be assembled according to the following method.

Referring to FIG. 8, terminal end 14 of retractable cable 12 is extended away from winch 16 and passed through hitch receiving receptacle 22. Terminal end 14 is then attached within inner cavity 58 of cable connector 56. As shown, terminal end 14 may be a loop that is positioned within cavity 58 that is engaged by a pin 62 that extends through cavity 58. Retractable cable 12 may be passed through cap 64 before being attached to cable connector 56; as such, terminal end 14 may be passed through opening 66 before the loop is formed at terminal end 14. Alternatively, cap 64 may be attached to outer sleeve 54 and around retractable cable 12 after terminal end 14 is attached to cable connector 56.

Referring to FIG. 7, cable connector 56 is then nested within outer sleeve 54 to form retractable hitch 40. When nested, outer sleeve 54 may prevent pin 62 from being removed and may be nested such that load-bearing surfaces 60a and 60b are in contact to transfer an applied load from retractable cable 12 to hitch connection 46 via cable connector 56 and outer sleeve 54. Cable connector 56 and outer sleeve 54 may be further secured through various known methods such as welding, adhesive, or pin connections. The shape of outer sleeve 54 may be substantially consistent along a length that is to be received within hitch-receiving receptacle 22. Cap 64 may be welded to first end 42. Other elements such as latch engaging profile 50 may also be required to be welded onto retractable hitch 20.

A method of hitching trailer 100 to vehicle 102 using retractable hitch assembly 10 will now be described.

When vehicle 102 is being operated, retractable hitch assembly 10 will generally have retractable cable 12 in the retracted state with releasable latch 70 securing retractable hitch 40 within hitch-receiving receptacle 22. Releasable latch 70 is released to allow for retractable hitch 40 to be removed from hitch-receiving receptacle 22. Retractable hitch 40 is extended away from stationary hitch receiver 20. Hitch connection 46 is attached to trailer 100, as shown in FIG. 9. In the example depicted in FIG. 9, trailer 100 may be attached using a hitch pin 106. Retractable cable 12 is then retracted from the extended state to the retracted state, such as by operating winch 16 to retract retractable cable 12. Retractable cable 12 is retracted to the retracted state where first end 42 of retractable hitch 40 is secured within hitch-receiving receptable 22 by releasable latch 70, as shown in FIG. 10. As retractable cable 12 is retracted, and first end 42 is being received within hitch-receiving receptacle 22, locking bar 72 of releasable latch 70 may be caused to pivot by ramp surface 52 to open releasable latch 70 to allow for latch engaging profile 50 to engage releasable latch 70. Once releasable latch 70 is engaged with latch engaging profile 50, retractable hitch 40 is in a connected state with stationary hitch receiver 20, and trailer 100 can be safely pulled by vehicle 102.

Winch 16 may be operated by a user remotely, such as by electronic communication through vehicle 102 or by radio frequency control such that after hitch connection 46 is attached to trailer 100, a user can be positioned at a safe distance away from retractable hitch assembly 10 until retractable hitch 40 is secured within hitch receiving receptacle 22.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A retractable hitch assembly, comprising:
a stationary hitch receiver comprising a hitch-receiving receptacle;
a retractable hitch having a first end that is sized to be received by the hitch-receiving receptacle and a second end that comprises a hitch connection;
a releasable latch that releasably secures the first end of the retractable hitch within the hitch-receiving receptacle; and
a retractable cable that extends through the hitch-receiving receptable and between the first end of the retractable hitch and the stationary hitch receiver, the retractable cable having an extended state and a retracted state, wherein, in the extended state, the retractable hitch is permitted to extend from the stationary hitch receiver, and in the retracted state, the retractable hitch is received within the hitch-receiving receptacle.

2. The retractable hitch assembly of claim 1, wherein the retractable hitch comprises a latch-engaging profile that engages the releasable latch when the retractable cable is in the retracted state, the releasable latch being biased toward an engaged position.

3. The retractable hitch assembly of claim 2, wherein the retractable hitch is released by actuating the releasable latch and pulling the first end of the retractable hitch from the hitch-receiving receptacle.

4. The retractable hitch assembly of claim 2, wherein the releasable latch comprises a locking bar biased downward, and the retractable hitch comprises a ramp that pivots the locking bar outward prior to the locking bar engaging the latch-engaging profile.

5. The retractable hitch assembly of claim 1, wherein the retractable hitch comprises an outer sleeve and a cable connector that nests within the outer sleeve, the cable connector comprising an inner cavity that houses and secures an end of the retractable cable such that the retractable cable extends out of inner cavity through the first end of the retractable hitch.

6. The retractable hitch assembly of claim 5, wherein the cable connector comprises a load-bearing surface that transfers a load applied by the retractable cable through the outer sleeve to the hitch connection of the retractable hitch.

7. The retractable hitch assembly of claim 6, wherein:
the retractable hitch further comprising a cap fixed to the first end; and
the load-bearing surface of the cable connector engages a complementary load bearing surface of the cap when the cable connector is nested within the outer sleeve, such that the load applied by the retractable cable is transferred through the cap to the outer sleeve.

8. The retractable hitch assembly of claim 5, wherein the retractable cable is secured to the cable connector by a pin disposed within the inner cavity, the pin being held by the outer sleeve when nested.

9. The retractable hitch assembly of claim 1, wherein the retractable cable is carried by a winch that is disposed in a winch housing, wherein the winch housing comprises a covered top and an open bottom.

10. A method of hitching a trailer to a vehicle, the method comprising the steps of:
extending a retractable hitch from a stationary hitch receiver secured to the vehicle, the stationary hitch receiver comprising a hitch-receiving receptacle, the retractable hitch having a first end that is sized to be received by the hitch-receiving receptacle and a second end that comprises a hitch connection for attaching to the trailer, the first end of the retractable hitch being connected to a retractable cable that extends through the hitch-receiving receptacle;
attaching the hitch connection of the retractable hitch to the trailer;
retracting the retractable cable from an extended state to a retracted state in which the retractable hitch is received within the hitch-receiving receptacle; and
securing the first end of the retractable hitch within the hitch-receiving receptacle with a releasable latch.

11. The method of claim 10, wherein the step of securing the first end of the retractable hitch in the retracted state comprises:
biasing the releasable latch towards an engaged position; and
engaging a latch-engaging profile of the retractable hitch with the releasable latch when the first end is received within hitch receiving receptacle and the releasable latch is in the engaged position.

12. The method of claim 11, further comprising the step of releasing the retractable hitch by releasing the releasable latch and pulling the first end of the retractable hitch from the hitch-receiving receptacle.

13. The method of claim 11, wherein the releasable latch comprises a locking bar that is biased downward, and the step of securing the first end of the retractable hitch in the retracted state further comprises causing the locking bar to move upward on a ramp of the retractable hitch prior to the locking bar engaging the latch-engaging profile.

14. The method of claim 10, wherein the step of retracting the retractable cable from the extended state to the retracted state comprises operating a winch to retract the retractable cable, the winch carrying the retractable cable and being housed in a winch housing that has a covered top and an open bottom.

15. A method of assembling a retractable hitch, the method comprising the steps of:
passing a terminal end of a retractable cable through a hitch-receiving receptacle of a stationary hitch receiver;
attaching the terminal end of the retractable cable to a cable connector, the terminal end of the retractable cable being secured to the cable connector within an inner cavity of a cable connector;
nesting the cable connector within an outer sleeve to form a retractable hitch, the retractable hitch being sized to be received within the hitch-receiving receptacle, the outer sleeve being connected to a hitch connection; and
attaching a releasable latch to the stationary hitch receiver, the releasable latch being configured to releasably secure the retractable hitch within the hitch-receiving receptacle.

16. The method of claim 15, wherein the step of attaching the terminal end of the retractable cable to the cable connector comprises attaching the cable to a pin disposed within the inner cavity, the pin being held by the outer sleeve when the cable connector is nested within the outer sleeve.

17. The method of claim 14, further comprising the step of closing the inner cavity by attaching a cap to a first end of the retractable hitch, the retractable cable passing through an aperture in the cap.

18. The method of claim 15, wherein the retractable cable is attached to a winch housed within the stationary hitch receiver, and the terminal end of the retractable cable extends away from the winch.

19. The method of claim 15, wherein the cable connector comprises a load-bearing surface that transfers a load applied by the retractable cable through the outer sleeve to the hitch connection of the retractable hitch.

20. The method of claim 18, further comprising the step of fixing a cap on a first end of the retractable hitch, wherein the cap comprises a complementary load bearing surface that engages the load-bearing surface of the cable connector.
